(19) United States
(12) Patent Application Publication
(10) Pub. No.: US 2026/0110390 A1
(43) Pub. Date: Apr. 23, 2026

(54) TILT DEVICE

(71) Applicant: NIDEC INSTRUMENTS CORPORATION, Nagano (JP)

(72) Inventor: SHOGO KASAHARA, Nagano (JP)

(73) Assignee: NIDEC INSTRUMENTS CORPORATION, Nagano (JP)

(21) Appl. No.: 19/358,437

(22) Filed: Oct. 15, 2025

(30) Foreign Application Priority Data
Oct. 18, 2024 (JP) 2024-183704

(51) Int. Cl. F16M 11/12

(52) U.S. Cl. CPC F16M 11/123

(57) ABSTRACT

A tilt device includes a gimbal mechanism that connects a holder to which a mirror being a swing target is fixed, and a support body. A gimbal frame includes a frame middle portion disposed inside the holder, a pair of first extension portions extending from the frame middle portion to both sides in a first axis direction within a plane including a first axis and a second axis, and a pair of second extension portions extending to both sides in a second axis direction within the same plane as that of the first extension portion. The pair of first extension portions are connected to the holder via a pair of first fulcrum portions provided inside the holder. The pair of second extension portions extend to an outside of the holder, and are connected to the support body via a pair of second fulcrum portions provided outside the holder.

### CROSS-REFERENCE TO RELATED APPLICATION

This application claims the priority benefit of Japan application serial no. 2024-183704, filed on October 18, 2024. The entirety of the above-mentioned patent application is hereby incorporated by reference herein and made a part of this specification.

### BACKGROUND

### Field of the Invention

At least an embodiment of the present invention relates to a tilt device.

### Description of the Related Documents

Conventionally, a tilt device that swings various members has been used. Japanese Unexamined Patent Application Publication No. 2019-33358 describes an antenna device with a shake correction function including a swing device (tilt device) that swings an antenna, which is an object to be swung, in two directions about a swing fulcrum on a central axis of the antenna.

As a device that swings an object to be swung in two directions, there are devices for various purposes other than the antenna device. For example, there are a mirror tilt device that swings a mirror, a device that swings another optical element, a laser pointer device that swings a light emitting element such as a laser diode, and the like.

Further, conventionally, there has been used an optical unit with a shake correction function including a swing device that swings a camera module including an imaging element and a lens unit about a swing fulcrum on an optical axis in two directions. Japanese Unexamined Patent Application Publication No. 2014-6522 and Japanese Unexamined Patent Application Publication No. 2020-160371 describe an optical unit with a shake correction function of this type.

The antenna device with a shake correction function described in Japanese Unexamined Patent Application Publication No. 2019-33358 is configured in such a way that an umbrella-shaped antenna is fixed to an upper end of a movable body holder made of resin. The movable body holder is connected to a fixed body holder that surrounds an outer circumference of the movable body holder via a gimbal member. The gimbal member is a flat plate spring in which an inner ring portion to be fixed to an outer circumference of a movable body, and an outer ring portion to be fixed to a fixed body are connected via an intermediate ring portion and a connection portion.

The optical unit with a shake correction function described in Japanese Unexamined Patent Application Publication No. 2014-6522 and Japanese Unexamined Patent Application Publication No. 2020-160371 connects a movable body and fixed body via a gimbal mechanism. In Japanese Unexamined Patent Application Publication No. 2014-6522, the gimbal mechanism includes a rectangular movable frame (gimbal member). The movable frame is configured in such a way that one of diagonal positions is in point contact with the movable body, and the fixed body is in point contact with the other of the diagonal positions. The movable frame is disposed in such a way as to surround an outer circumference of an optical module provided in the movable body. On the other hand, in Japanese Unexamined Patent Application Publication No. 2020-160371, a shape of a gimbal frame (gimbal member) of the gimbal mechanism is a shape including a first frame portion that overlaps the movable body in an optical axis direction, and a second frame portion that is bent from a diagonal position of the first frame portion in the optical axis direction, and is connected to the movable body or the fixed body.

As described above, in a conventional tilt device, in a case where a gimbal mechanism is used as a swing support mechanism, a space in which a gimbal member is disposed is required in a gap between a movable body and a fixed body. Therefore, a planar size of the device increases. As exemplified in Japanese Unexamined Patent Application Publication No. 2020-160371, it is possible to dispose a part of a gimbal member at a position where the gimbal member overlaps a movable body in an optical axis direction. However, in this case, a size of the device in a height direction increases.

### SUMMARY

An aspect of a tilt device according to at least an embodiment of the present invention includes: a holder to which a swing target is fixed to an outside; a support body that surrounds an outer circumference of the holder; a gimbal mechanism that connects the holder and the support body; and a swing magnetic drive mechanism including a magnet to be fixed to one of the support body and the holder, and a coil to be fixed to the other of the support body and the holder. In a case where an axis intersecting with a central axis line connecting between a swing center located inside of the holder, and the swing target at the swing center is referred to as a first axis, and an axis intersecting with the central axis line and the first axis at the swing center is referred to as a second axis, the gimbal mechanism includes a gimbal frame that swingably supports the holder about the first axis as a center. The gimbal frame is swingably supported about the second axis as a center with respect to the support body. The gimbal frame includes a frame middle portion that is disposed inside of the holder, a pair of first extension portions extending from the frame middle portion to both sides of the gimbal frame in a first axis direction along the first axis within a plane including the first axis and the second axis, and a pair of second extension portions extending to both sides of the gimbal frame in a second axis direction along the second axis within a same plane as the plane of the first extension portion. The pair of the first extension portions are connected to the holder via a pair of first fulcrum portions provided inside of the holder. The pair of the second extension portions extend to an outside of the holder, and are connected to the support body via a pair of second fulcrum portions provided outside of the holder.

### BRIEF DESCRIPTION OF THE DRAWINGS

Embodiments will now be described, by way of example only, with reference to the accompanying drawings which are meant to be exemplary, not limiting, and wherein like elements are numbered alike in several figures, in which:

FIG. 1 is an external perspective view of a tilt device that swings a mirror;

FIG. 2 is an exploded perspective view of the mirror and the tilt device;

FIG. 3 is a cross-sectional view of the tilt device taken along an XY plane;

FIG. 4 is a cross-sectional view of the tilt device taken along a plane including a first axis and a Z-axis;

FIG. 5 is a cross-sectional view of the tilt device taken along a plane including a second axis and the Z axis;

FIG. 6 is an exploded perspective view of a gimbal frame, a first spring member, and a second spring member;

FIG. 7 is a perspective view of a holder when viewed from a Z2 side; and

FIG. 8 is a cross-sectional view of the tilt device taken along a position of a third stopper portion.

### DETAILED DESCRIPTION

At least an embodiment of the present invention reduces the size and the weight of a tilt device using a gimbal mechanism as a swing support mechanism.

Hereinafter, description is made on an embodiment of a tilt device to which at least an embodiment of the present invention is applied with reference to the drawings.

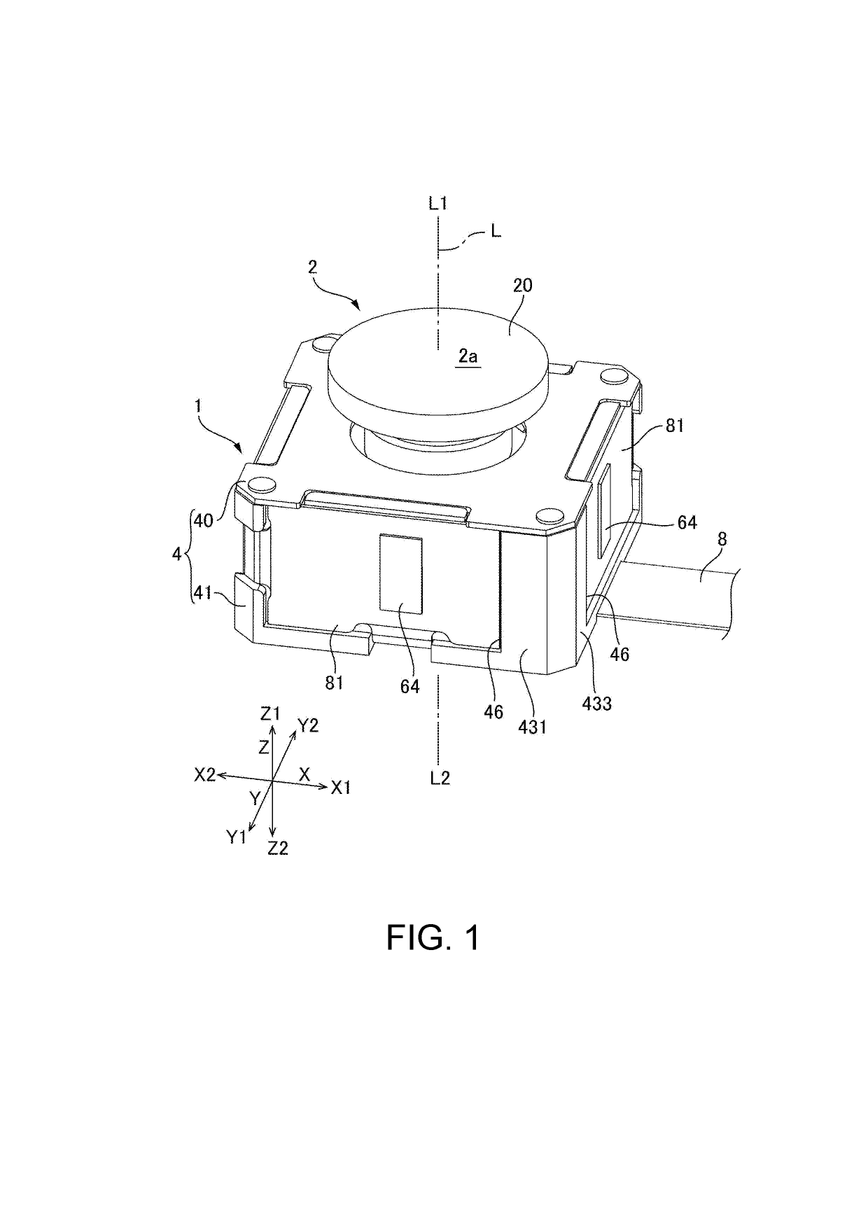

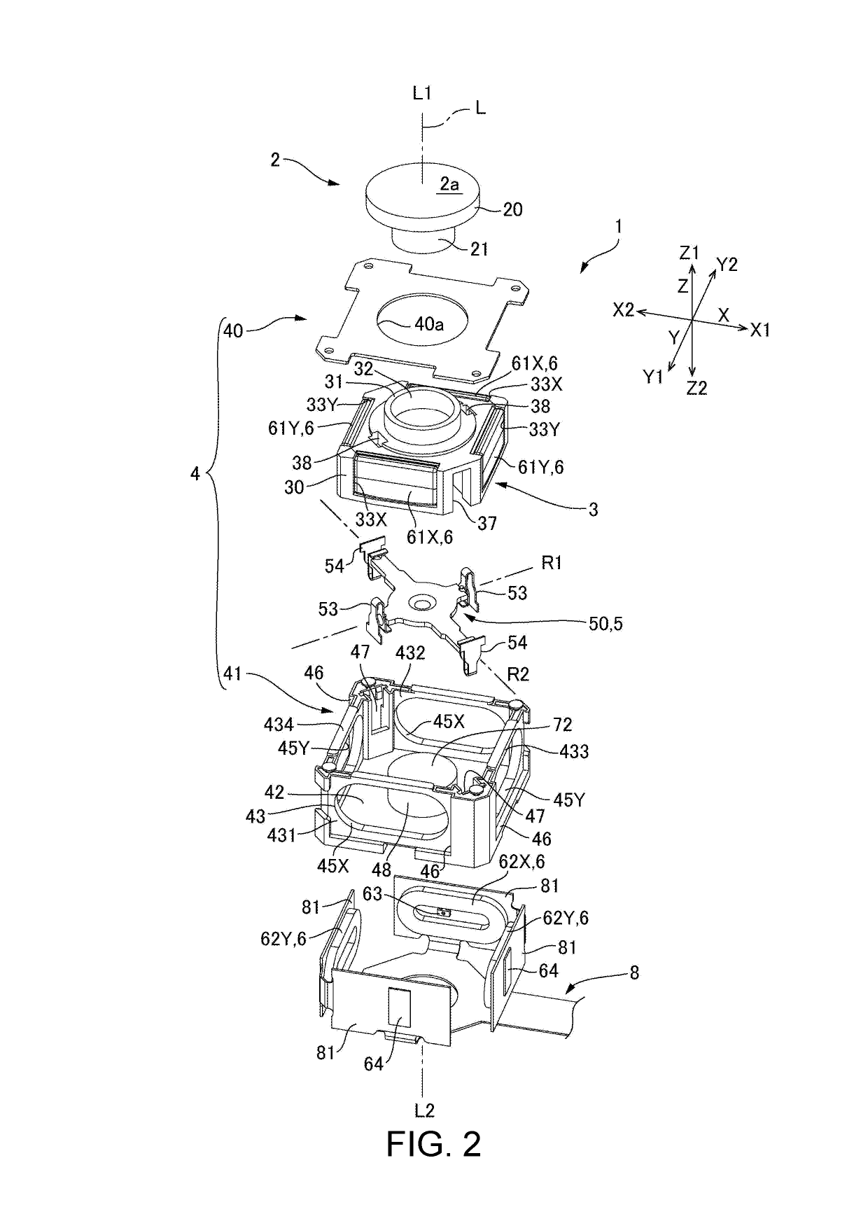

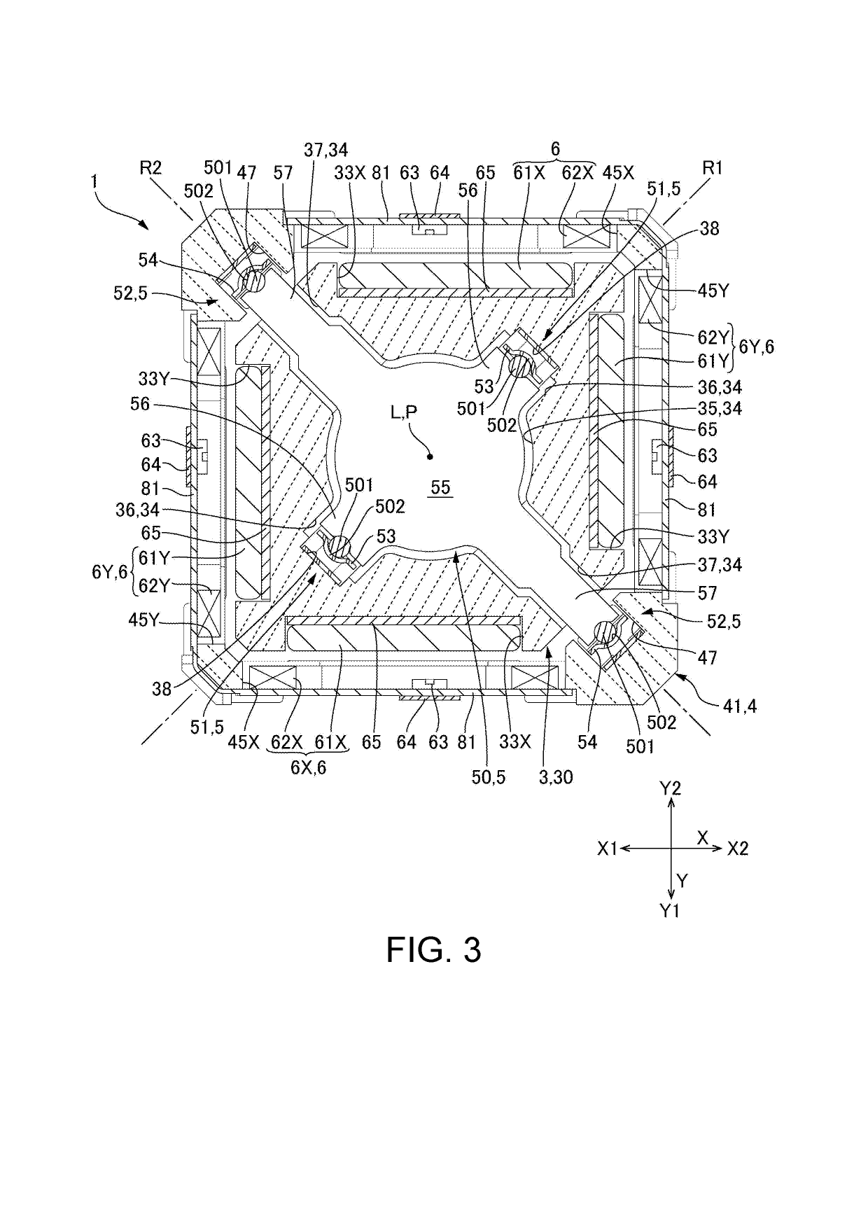

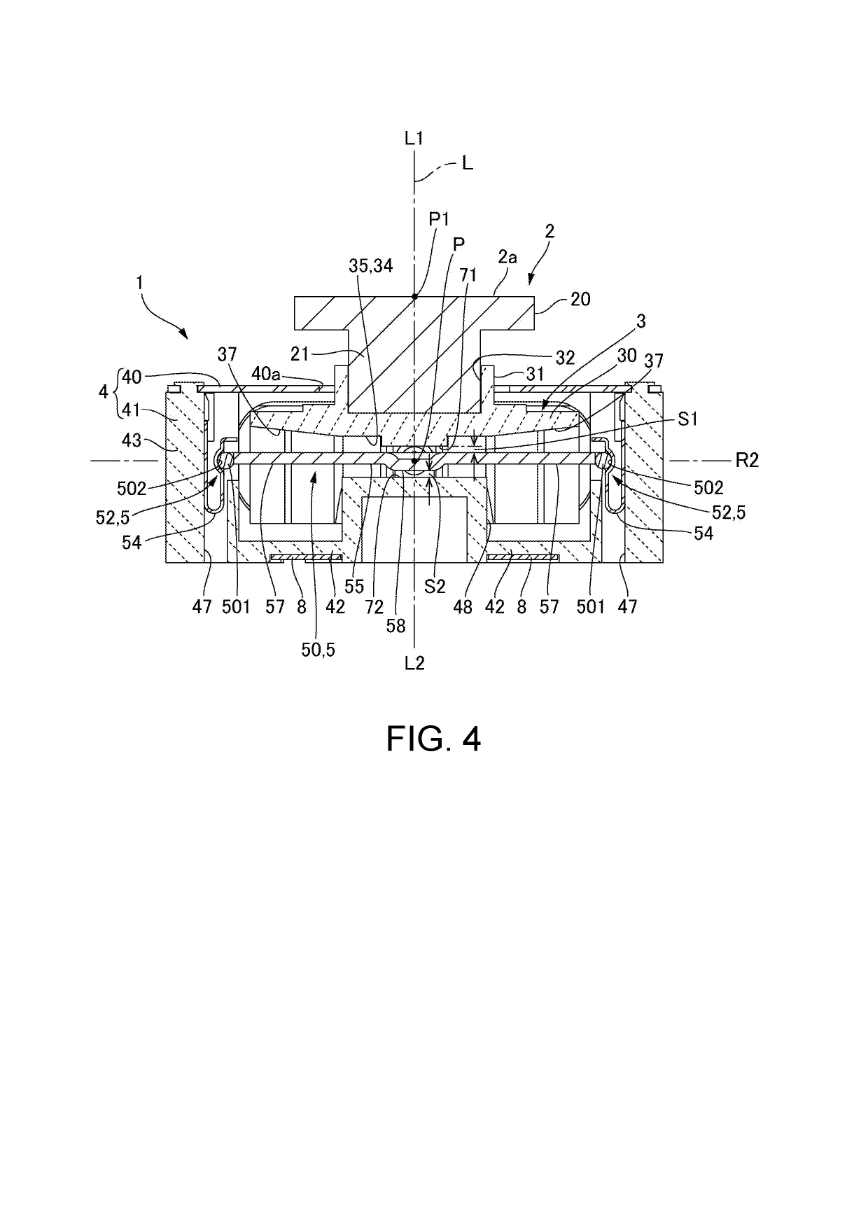

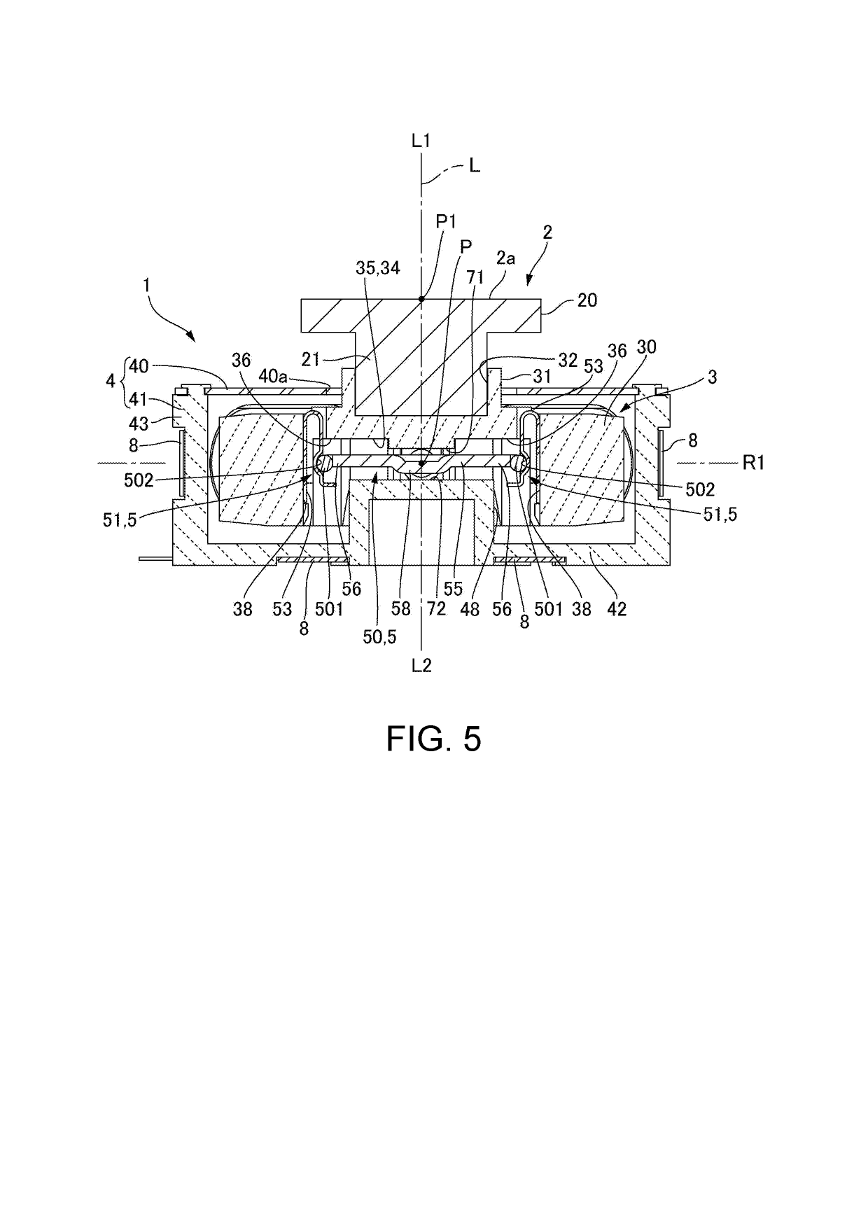

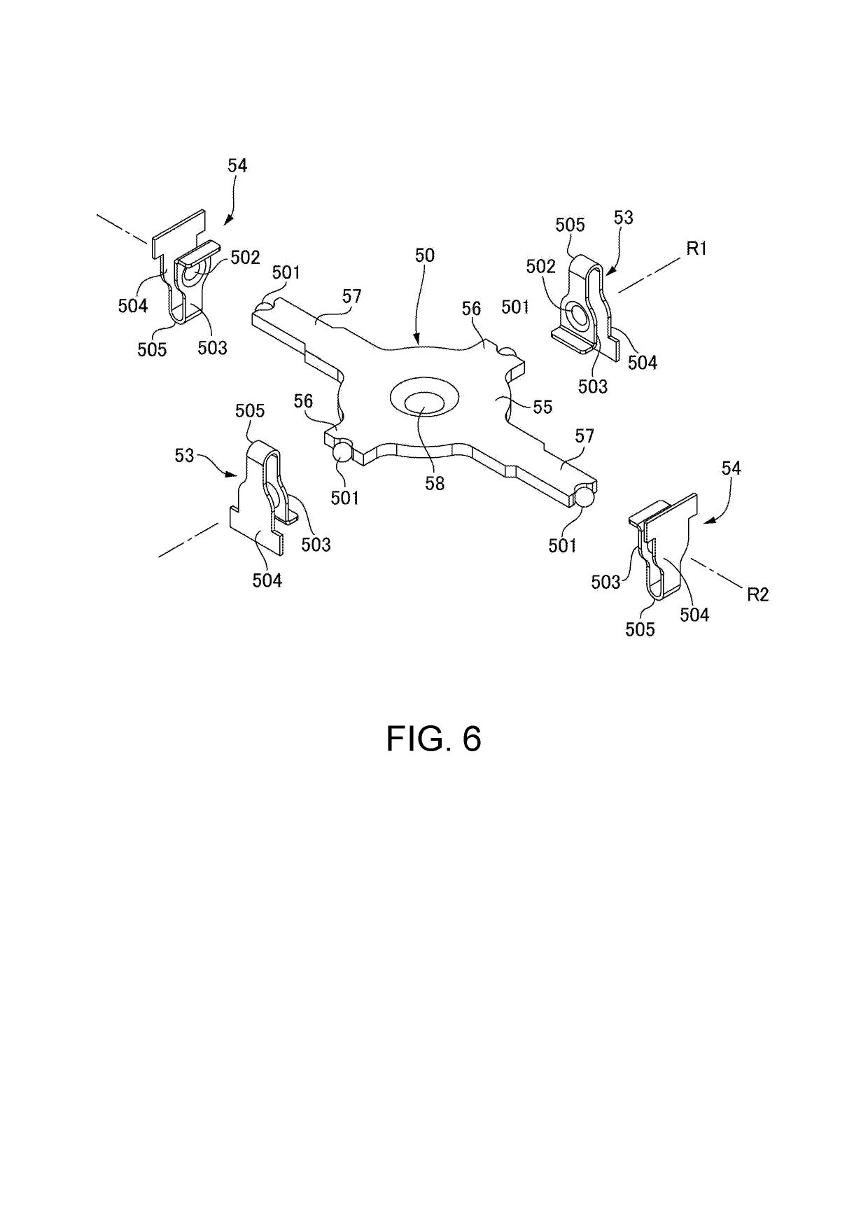

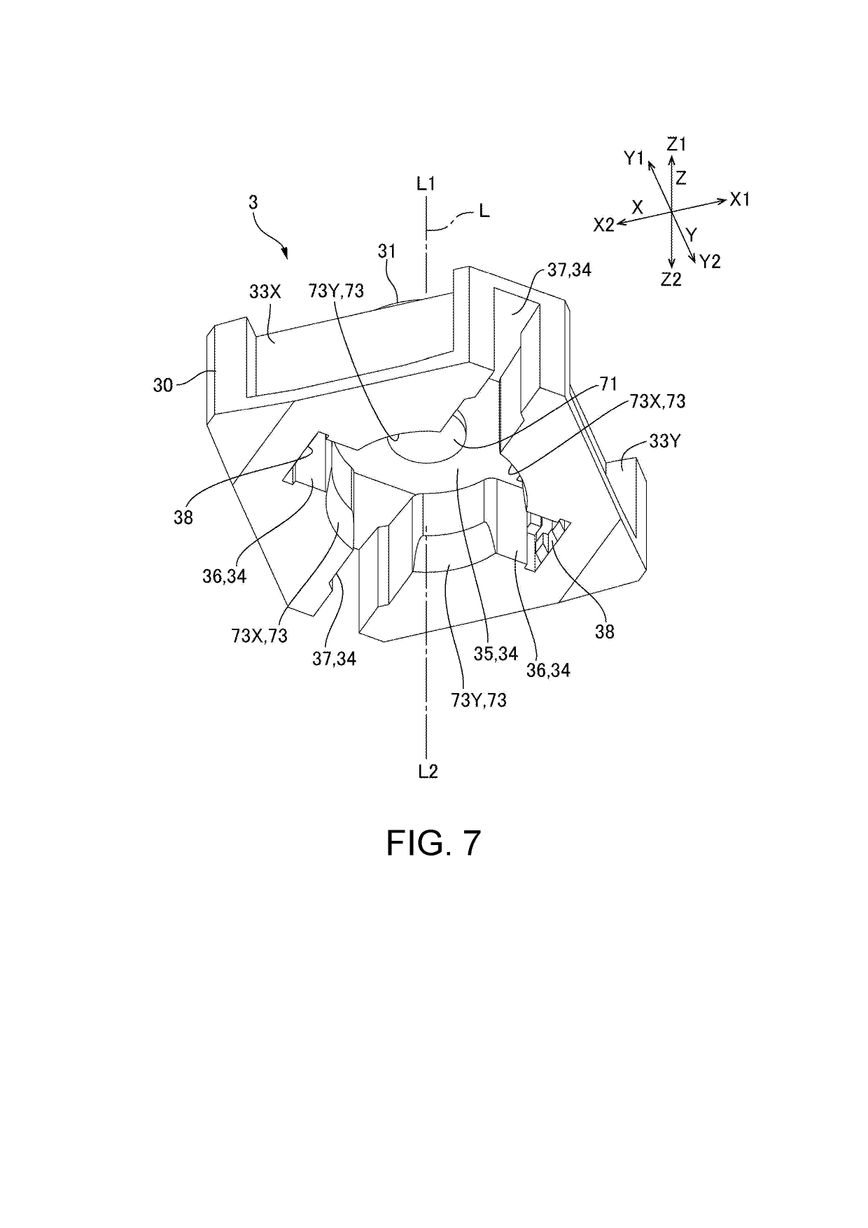

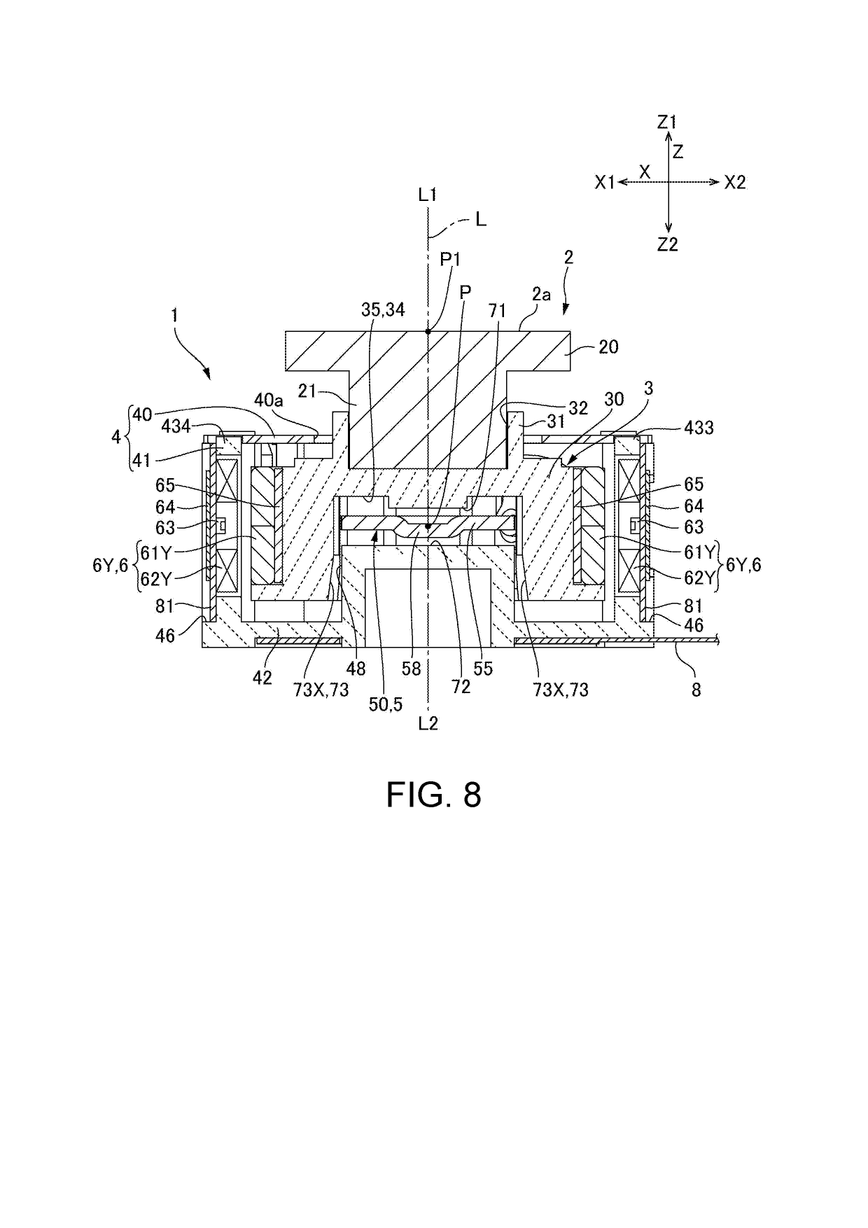

FIG. 1 is an external perspective view of a tilt device 1 that swings a mirror 2. FIG. 2 is an exploded perspective view of the mirror 2 and the tilt device 1. FIG. 3 is a cross-sectional view of the tilt device 1 taken along an XY plane. FIG. 4 is a cross-sectional view of the tilt device 1 taken along a plane including a first axis R1 and a Z-axis. FIG. 5 is a cross-sectional view of the tilt device 1 taken along a second axis R2 and the Z-axis. FIG. 6 is an exploded perspective view of a gimbal frame 50, a first spring member 53, and a second spring member 54. FIG. 7 is a perspective view of a holder 3 when viewed from the Z2 side. FIG. 8 is a cross-sectional view of the tilt device 1 taken along a position of a third stopper portion 73.

The tilt device 1 performs a tilt operation of swinging an object to be swung. The object to be swung is not specifically limited. However, for example, a reflective member such as a mirror, an antenna, an optical member such as a lens and a prism, a light emitting element such as a laser diode, and the like are exemplified. The tilt device 1 performs a tilt operation of swinging an object to be swung, for example, based on a control signal from a host device. Hereinafter, an embodiment in which an object to be swung is the mirror 2 is described.

### Overall Configuration

As illustrated in FIGS. 1 to 5, the tilt device 1 includes the holder 3 made of resin and to which the mirror 2 is fixed, a support body 4 that surrounds an outer circumference of the holder 3, a gimbal mechanism 5 that connects the holder 3 and the support body 4, and a swing magnetic drive mechanism 6 that generates a magnetic driving force for swinging the holder 3. The swing magnetic drive mechanism 6 includes a first magnet 61X and a second magnet 61Y to be fixed to the holder 3, and a first coil 62X and a second coil 62Y to be fixed to the support body 4. Note that, the first coil 62X and the second coil 62Y may be disposed on the holder 3, and the first magnet 61X and the second magnet 61Y may be disposed on the support body 4.

The mirror 2 includes a mirror body 20 including a circular reflective surface 2a, and a convex portion 21 protruding from a middle of the mirror body 20 to a side opposite to the reflective surface 2a. As illustrated in FIGS. 4 and 5, the mirror 2 is fixed to the outside of the holder 3 via the convex portion 21. The mirror 2 and the holder 3 constitute a movable body that swings as a unit. As will be described later, the tilt device 1 of the present embodiment is configured in such a way that a part of the gimbal mechanism 5 is accommodated inside of the holder 3, and a swing center P of the movable body including the mirror 2 and the holder 3 is located in an internal space of the holder 3. Therefore, the swing center P is located outside of the mirror 2, which is an object to be swung, and the mirror 2 is away from the swing center P.

In the following description, three axes orthogonal to each other are referred to as an X-axis, a Y-axis, and the Z-axis. The Z-axis coincides with a central axis line L that connects between a position of the mirror 2 at which the mirror 2 being an object to be swung is attached to the holder 3, and the swing center P. As illustrated in FIGS. 4 and 5, the central axis line L is a straight line passing through a center point P1of the reflective surface 2a of the mirror 2 and the swing center P, and coincides with an optical axis of the reflective surface 2a.

The gimbal mechanism 5 swingably supports the holder 3 about the first axis R1 as a center, and swingably supports the holder 3 about the second axis R2 as a center. The first axis R1 and the second axis R2 intersect with each other, and intersect with the Z-axis at the swing center P. The first axis R1 and the second axis R2are inclined with respect to the X-axis and the Y-axis about the Z-axis. In the present embodiment, the first axis R1, the second axis R2, and the Z-axis are orthogonal to each other. Further, the first axis R1 and the second axis R2 are inclined with respect to the X-axis and the Y-axis by 45 degrees about the Z-axis. The X-axis is a third axis. The Y-axis is a fourth axis.

The tilt device 1 cooperatively performs an operation of swinging the holder 3 about the first axis R1 as a center, and an operation of swinging the holder 3 about the second axis R2 as a center. Thus, an angular position of the mirror 2 fixed to the holder 3 about the X-axis, and an angular position of the mirror 2 about the Y-axis are adjusted.

Note that, the gimbal mechanism 5 may be configured in such a way that the first axis R1 and the second axis R2 are not inclined with respect to the X-axis and the Y-axis. For example, one of the first axis R1 and the second axis R2 may coincide with one of the X-axis and the Y-axis. In this case, the other of the first axis R1 and the second axis R2 may coincide or may not coincide with the other of the X-axis and the Y-axis.

In the following description, a direction along the X-axis is referred to as an X-axis direction, a direction along the Y-axis is referred to as a Y-axis direction, and a direction along the Z-axis is referred to as a Z-axis direction. One side in the X-axis direction is referred to as an X1 direction, the other side in the X-axis direction is referred to as an X2 direction, one side in the Y-axis direction is referred to as a Y1 direction, the other side in the Y-axis direction is referred to as a Y2 direction, one side in the Z-axis direction is referred to as a Z1 direction, and the other side in the Z-axis direction is referred to as a Z2 direction. The mirror 2 is located on the Z1 side of the holder 3. Further, a direction along the first axis R1 is referred to as a first axis direction, and a direction along the second axis R2 is referred to as a second axis direction.

### Support Body

As illustrated in FIGS. 1, 2, and 3, the support body 4 includes a case 41 made of resin, and a plate-shaped cover 40 to be fixed to an end surface of the case 41 in the Z1 direction. The cover 40 is made of non-magnetized metal. In a case where the tilt device 1 is assembled, a mirror attachment portion 31 of the holder 3 protrudes in the Z1 direction through a circular opening portion 40a provided in the middle of the cover 40. The mirror 2 is fixed to a lead end portion of the mirror attachment portion 31.

A planar shape of the case 41 when viewed from the Z-axis direction is a rectangular shape. The case 41 includes a bottom portion 42 located on the Z2 side of the holder 3, and a side wall portion 43 that is connected to an outer edge of the bottom portion 42, and surrounds the outer circumference of the holder 3. The side wall portion 43 includes a first wall 431 and a second wall 432 facing to each other in the Y-axis direction, and a third wall 433 and a fourth wall 434 facing to each other in the X-axis direction.

### Swing Magnetic Drive Mechanism

As illustrated in FIG. 2, a first coil fixing portion 45X is provided on each of the first wall 431 and the second wall 432 of the case 41. The first coil 62X of the swing magnetic drive mechanism 6 is disposed on the first coil fixing portion 45X. The first coil 62X is an oval air core coil extending in the X-axis direction. Likewise, a second coil fixing portion 45Y is provided on each of the third wall 433 and the fourth wall 434. The second coil 62Y of the swing magnetic drive mechanism 6 is disposed on the second coil fixing portion 45Y. The second coil 62Y is an oval air core coil extending in the Y-axis direction.

As illustrated in FIG. 2, the first magnet 61X is fixed to each of side surfaces of the holder 3 in the Y-axis direction. The second magnet 61Y is fixed to each of side surfaces of the holder 3 in the X-axis direction. The first magnet 61X and the second magnet 61Y are polarized and magnetized in the Z-axis direction. As illustrated in FIG. 3, the swing magnetic drive mechanism 6 includes two pairs each constituting the first magnet 61X and the first coil 62X facing to each other in the Y-axis direction, and two pairs each constituting the second magnet 61Y and the second coil 62Y facing to each other in the X-axis direction. The pair of the first magnet 61X and the first coil 62X constitutes a first magnetic drive mechanism 6X that generates a magnetic driving force that swings the holder 3 about the X-axis. The pair of the second magnet 61Y and the second coil 62Y constitutes a second magnetic drive mechanism 6Y that generates a magnetic driving force that swings the holder 3 about the Y-axis.

As illustrated in FIG. 2, the first coil 62X and the second coil 62Y are electrically connected to a flexible printed circuit board 8, and electric power is supplied via the flexible printed circuit board 8. The flexible printed circuit board 8 includes a coil connection portion 81 at four positions, which is fitted in a recess portion 46 provided in an outer circumferential surface of the first wall 431, the second wall 432, the third wall 433, and the fourth wall 434 of the case 41. The flexible printed circuit board 8 extends from the recess portion 46 toward the bottom portion 42, and is drawn out in the X1 direction of the case 41 via outside of the bottom portion 42.

A magnetic sensor 63 disposed inside of the first coil 62X and the second coil 62Y is connected to each coil connection portion 81. Further, in each coil connection portion 81, a magnetized member 64 for returning to an original position is fixed to a back surface of the first coil 62X and the second coil 62Y. The swing magnetic drive mechanism 6 detects an angular position of the holder 3 and the mirror 2, based on an output of the magnetic sensor 63. Further, in a case where electric power supply to the first coil 62X and the second coil 62Y is stopped, the holder 3 and the mirror 2 are returned to the original position by a magnetic suction force that sucks the magnetized member 64 by a magnet fixed to the holder 3.

### Holder

The holder 3 includes a holder body 30 to be accommodated inside of the case 41, and the mirror attachment portion 31 protruding in the Z1 direction from a middle of an end portion of the holder body 30 in the Z1 direction. A concave portion 32 into which the convex portion 21 of the mirror 2 is fitted is provided in the mirror attachment portion 31. The holder body 30 has a rectangular shape in which a planar shape when viewed from the Z-axis direction is smaller than that of the case 41, and is disposed inside of the side wall portion 43 of the case 41. A first magnet fixing portion 33X that is recessed to an inner circumference of the holder 3 is provided on each of a side surface on a Y1 side and a side surface on a Y2 side of the holder body 30. A yoke 65 is disposed on the first magnet fixing portion 33X, and the first magnet 61X is fixed to the outside of the yoke 65. Likewise, a second magnet fixing portion 33Y that is recessed to the inner circumference of the holder 3 is provided in each of a side surface on an X1 side and a side surface on an X2 side of the holder body 30. A yoke 65 is disposed on the second magnet fixing portion 33Y, and the second magnet 61Y is fixed to the outside of the yoke 65.

As illustrated in FIGS. 4, 5, and 7, a holder concave portion 34 that is opened to a side opposite to the mirror 2 is provided in the holder body 30. A part of the gimbal mechanism 5 is accommodated in the holder concave portion 34. As illustrated in FIGS. 3 and 7, the holder concave portion 34 includes a middle concave portion 35 provided in the middle of the holder body 30, a pair of first groove portions 36 extending from the middle concave portion 35 to both sides of the holder 3 in the first axis direction, and a pair of second groove portions 37 extending from the middle concave portion 35 to both sides of the holder 3 in the second axis direction. The first groove portion 36 does not extend to an outer circumferential surface of the holder body 30, and does not pass through the holder body 30 in the first axis direction. On the other hand, the second groove portion 37 passes through the holder body 30 in the second axis direction, and is opened to an outer circumferential surface of the holder body 30 at a diagonal position in the second axis direction.

As illustrated in FIGS. 2 and 3, the holder body 30 has a shape in which a diagonal portion in the second axis direction is cut out, and the second groove portion 37 is opened in the cutout portion. Accompanied by cutting out of the diagonal portion of the holder body 30 in the second axis direction, each side surface of the holder body 30 is cut out on a side at a diagonal position in the second axis direction. Accompanied by this, the first magnet fixing portion 33X is provided at a position shifted to the side of the diagonal position in the first axis direction with respect to a center of the holder body 30 in the X-axis direction. Further, the second magnet fixing portion 33Y is provided at a position shifted to the side of the diagonal position in the first axis direction with respect to a center of the holder body 30 in the Y-axis direction.

In this way, shifting each magnet fixing portion to a side of a diagonal position in the first axis direction enables to increase a size of the magnet fixing portion on a side surface of the holder body 30, and attach a large magnet, while avoiding interference with a second extension portion 57 of the gimbal frame 50. As illustrated in FIG. 3, the first magnet 61X is not attached to a center of the holder body 30 in the X-axis direction, but is attached to a position shifted from the center of the holder body 30 in the X-axis direction to a side of a diagonal position in the first axis direction. Likewise, the second magnet 61Y is not attached to a center of the holder body 30 in the Y-axis direction, but is attached to a position shifted from the center of the holder body 30 in the Y-axis direction to a side of a diagonal position in the first axis direction. On the other hand, both of the magnetic sensor 63 and the magnetized member 64 for returning to an original position that are disposed on the support body 4 are disposed at a center of the holder body 30 in the X-axis direction, or at a position facing a center of the holder body 30 in the Y-axis direction.

### Gimbal Mechanism

As illustrated in FIGS. 3, 4 and 5, the gimbal mechanism 5 includes the gimbal frame 50, a first fulcrum portion 51 provided on the holder body 30, and a second fulcrum portion 52 provided at two positions on the case 41. As illustrated in FIG. 6, the gimbal frame 50 is a plate-shaped rigid body in which the Z-axis direction is a plate thickness direction. A spherical body 501 made of metal is fixed by welding at four positions, i.e., at both ends of the gimbal frame 50 in the first axis direction and at both ends of the gimbal frame 50 in the second axis direction.

As illustrated in FIGS. 3 and 5, the first fulcrum portion 51 is disposed on both sides of the gimbal frame 50 in the first axis direction, and is in point contact, on the first axis R1, with the spherical body 501 fixed to both ends of the gimbal frame 50 in the first axis direction. As illustrated in FIGS. 3 and 4, the second fulcrum portion 52 is disposed on both sides of the gimbal frame 50 in the second axis direction, and is in point contact, on the second axis R2, with the spherical body 501 fixed to both ends of the gimbal frame 50 in the second axis direction. This allows for the holder 3 to be swingably supported about the first axis by the gimbal frame 50, and allows for the gimbal frame 50 to be swingably supported about the second axis by the support body 4.

As illustrated in FIGS. 3 and 5, the first fulcrum portion 51 includes a first spring attachment portion 38 provided on the holder body 30, and the first spring member 53 to be mounted to the first spring attachment portion 38. As illustrated in FIG. 5, the first spring attachment portion 38 extends from a lead end of the first groove portion 36 of the holder concave portion 34 in the Z1 direction, and passes through the holder body 30 in the Z-axis direction.

As illustrated in FIGS. 3 and 4, the second fulcrum portion 52 includes a second spring attachment portion 47 provided on the case 41, and the second spring member 54 to be mounted to the second spring attachment portion 47. As illustrated in FIG. 4, the second spring attachment portion 47 is recessed from an inner circumferential surface of a diagonal portion of the case 41 in the second axis direction toward an outer circumference thereof, extends in the Z2 direction, and passes through the case 41 in the Z-axis direction.

As illustrated in FIG. 6, the first spring member 53 and the second spring member 54 have an identical shape, and are used in an opposite direction to each other in the Z-axis direction. The first spring member 53 and the second spring member 54 are a plate spring whose shape is folded one time in the Z-axis direction. The first spring member 53 and the second spring member 54 include a first plate portion 503 in which a concave curved surface 502 in point contact with the spherical body 501 is formed, a second plate portion 504 extending in parallel to the first plate portion 503, and a bent portion 505 that connects the first plate portion 503 and the second plate portion 504. The concave curved surface 502 is recessed in a direction directed from the first plate portion 503 toward the second plate portion 504.

As illustrated in FIG. 3, the first spring member 53 is mounted to the first spring attachment portion 38 with the concave curved surface 502 being directed toward an inner circumference thereof. The second spring member 54 is mounted to the second spring attachment portion 47 with the concave curved surface 502 being directed toward an inner circumference thereof. In a case where the gimbal mechanism 5 is assembled, the first plate portion 503 of a pair of the first spring members 53, and the first plate portion 503 of a pair of the second spring members 54 are flexed toward an outer circumference thereof, and then, the gimbal frame 50 is mounted. This allows for the concave curved surface 502 to be urged toward the spherical body 501 from both sides of the gimbal frame 50 in the first axis direction, and from both sides of the gimbal frame 50 in the second axis direction, thereby maintaining a state in which a center of the concave curved surface 502 and a lead end of the spherical body 501 are in point contact with each other on the first axis R1 and on the second axis R2.

As illustrated in FIGS. 2 and 6, the gimbal frame 50 includes a frame middle portion 55 of a circular shape when viewed from the Z-axis direction, a pair of first extension portions 56 extending from the frame middle portion 55 to both sides of the gimbal frame 50 in the first axis direction, and a pair of the second extension portions 57 extending from the frame middle portion 55 to both sides of the gimbal frame 50 in the second axis direction within the same plane as the plane of the first extension portion 56. A reinforcement portion 58 of a circular shape and being recessed in the Z2 direction is provided on the middle of the frame middle portion 55. As illustrated in FIGS. 4 and 5, a portion of the gimbal frame 50 other than the reinforcement portion 58 is located within the same plane as the plane including the first axis R1 and the second axis R2.

The gimbal frame 50 is disposed on the holder concave portion 34 provided in the holder body 30. As illustrated in FIG. 3, the frame middle portion 55 is disposed on the middle concave portion 35 of the holder concave portion 34, the first extension portion 56 is disposed on the first groove portion 36, and the second extension portion 57 is disposed on the second groove portion 37. In the gimbal frame 50, a concave portion recessed to an inner circumference thereof is formed in a lead end surface of each of the first extension portion 56 and the second extension portion 57, and the spherical body 501 is welded to the concave portion. This allows for a convex curved surface in point contact with the concave curved surface 502 to be disposed at both ends of the gimbal frame 50 in the first axis direction, and at both ends of the gimbal frame 50 in the second axis direction.

Note that, a configuration may be adopted in which a convex portion is provided in place of fixing the spherical body 501 to both ends of the gimbal frame 50 in the first axis direction, and to both ends of the gimbal frame 50 in the second axis direction, and a convex curved surface in point contact with the concave curved surface 502 is provided on a lead end of the convex portion.

Since the gimbal frame 50 includes the reinforcement portion 58, rigidity of the frame middle portion 55 increases. Further, in the present embodiment, as illustrated in FIGS. 4 and 5, since a center of the gimbal frame 50 in the plate thickness direction and a center of the spherical body 501 are deviated from each other, it is necessary to assemble the device by discriminating the front and the back of the gimbal frame 50. Providing the reinforcement portion 58 makes it easy to discriminate the front and the back of the gimbal frame 50. Note that, a configuration of the frame middle portion 55 is not limited to the above configuration. For example, a planar shape of the frame middle portion 55 is not limited to a circular shape. Further, a penetration portion that passes through a middle of the frame middle portion 55 may be provided.

### Stopper Mechanism

As illustrated in FIGS. 4 and 5, the tilt device 1 includes a first stopper portion 71 and a second stopper portion 72 facing to each other in the Z-axis direction with respect to the frame middle portion 55 of the gimbal frame 50. In a case where an impact due to falling or the like is added, the tilt device 1 causes the frame middle portion 55 that is reinforced by the reinforcement portion 58 to collide against the first stopper portion 71 or the second stopper portion 72 first. This avoids that another portion is damaged by collision.

The first stopper portion 71 is provided in the holder 3. As illustrated in FIG. 7, the first stopper portion 71 is a circular convex portion protruding, in the Z2 direction, from a middle of a bottom surface of the middle concave portion 35 of the holder concave portion 34. As illustrated in FIG. 4, the first stopper portion 71 faces a portion of the frame middle portion 55 that surrounds an outer circumference of the reinforcement portion 58. A gap S1 in the Z-axis direction between the first stopper portion 71 and the frame middle portion 55 is smaller than a gap in the Z2 direction between the case 41 and the holder 3. Therefore, when falling, the first stopper portion 71 collides against the frame middle portion 55 before the holder 3 collides against the case 41.

The second stopper portion 72 is provided in the case 41. As illustrated in FIG. 2, the case 41 includes a circular convex portion 48 protruding from a middle of the bottom portion 42 in the Z1 direction, and a lead end portion of the circular convex portion 48 functions as the second stopper portion 72. As illustrated in FIGS. 4 and 5, the lead end portion (second stopper portion 72) of the circular convex portion 48 is disposed inside of the middle concave portion 35. The second stopper portion 72 faces the reinforcement portion 58 of the frame middle portion 55. A gap S2 in the Z-axis direction between the second stopper portion 72 and the reinforcement portion 58 is smaller than the gap in the Z2 direction between the case 41 and the holder 3. Therefore, when falling, the second stopper portion 72 collides against the frame middle portion 55 before the holder 3 collides against the case 41.

As illustrated in FIGS. 7 and 8, a portion of the holder body 30 in which an inner surface of the middle concave portion 35 faces an outer circumferential surface of the circular convex portion 48 of the case 41 in a radial direction functions as the third stopper portion 73 for restricting a swing range of the holder 3. The third stopper portion 73 is an inclined surface being inclined in a direction toward an inner circumference thereof (in other words, a side of the central axis line L), as the third stopper portion 73 is directed toward the swing center P in the Z-axis direction (in the present embodiment, the Z1 direction). As illustrated in FIG. 7, the third stopper portion 73 includes a pair of first inclined surfaces 73X facing to each other in the X-axis direction, and a pair of second inclined surfaces 73Y facing to each other in the Y-axis direction. Therefore, a swing range of the holder 3 about the X-axis is restricted by the first inclined surface 73X, and a swing range of the holder 3 about the Y-axis is restricted by the second inclined surface 73Y.

### Advantageous Effects

As described above, the tilt device 1 of the present embodiment includes the holder 3 including the mirror attachment portion 31 as a swing target attachment portion for fixing the mirror 2 to the outside; the support body 4 that surrounds the outer circumference of the holder 3; the gimbal mechanism 5 that connects the holder 3 and the support body 4, and the swing magnetic drive mechanism 6 including the first magnet 61X and the second magnet 61Y to be fixed to the holder 3, and the first coil 62X and the second coil 62Y to be fixed to the support body 4. In a case where an axis intersecting with the central axis line L connecting between the swing center P located inside of the holder 3, and a position of the mirror 2 when being attached to the mirror attachment portion 31 at the swing center P is referred to as the first axis R1, and an axis intersecting with the central axis line L and the first axis R1 at the swing center P is referred to as the second axis R2, the gimbal mechanism 5 includes the gimbal frame 50 that swingably supports the holder 3 about the first axis R1 as a center. The gimbal frame 50 is swingably supported about the second axis R2 as a center with respect to the support body 4. The gimbal frame 50 includes the frame middle portion 55 that is disposed inside of the holder 3, a pair of the first extension portions 56 extending from the frame middle portion 55 to both sides of the gimbal frame 50 in the first axis direction within a plane including the first axis R1 and the second axis R2, and a pair of the second extension portions 57 extending to both sides of the gimbal frame 50 in the second axis direction within the same plane as the plane of the first extension portion 56. The pair of the first extension portions 56 are connected to the holder 3 via a pair of the first fulcrum portions 51 provided inside of the holder 3. The pair of the second extension portions 57 extend to the outside of the holder 3, and are connected to the support body 4 via a pair of the second fulcrum portions 52 provided outside of the holder 3.

In the present embodiment, the mirror 2 being a swing target is disposed outside of the holder 3, and a major part of the gimbal frame 50 and the first fulcrum portion 51 are disposed inside of the holder 3. Therefore, it is possible to make the gimbal mechanism 5 compact and simple. For example, in the present embodiment, since an installation space for the gimbal frame 50 can be secured inside of the holder 3, it is possible to make the gimbal frame 50 into a planar shape. Further, it is not necessary to secure an installation space for the first extension portion 56 and the first fulcrum portion 51 outside of the holder 3. Therefore, it is possible to reduce the plane size and the height of the device, and reduce the weight of the device.

The gimbal frame 50 of the present embodiment is a plate-shaped rigid body in which a direction perpendicular to a plane including the first axis and the second axis, in other words, a central axis direction along the central axis line L is a plate thickness direction. Therefore, it is possible to make a part shape simple and compact, and reduce the weight of a part. Further, using a rigid body enables to increase shock resistance.

The gimbal frame 50 of the present embodiment includes the reinforcement portion 58 that is recessed in the frame middle portion 55 in the plate thickness direction. In a case of a plate-shaped part, the front and the back of the part may not be easily discriminated. However, providing the reinforcement portion 58 as described above makes it easy to discriminate the front and the back. Further, providing the reinforcement portion 58 enables to increase rigidity of a part. Therefore, it is possible to increase shock resistance.

The holder 3 of the present embodiment includes the holder concave portion 34 being opened in a direction along the central axis line L. The holder concave portion 34 includes the middle concave portion 35 in which the frame middle portion 55 is disposed, a pair of the first groove portions 36 extending from the middle concave portion 35 to both sides of the holder 3 in the first axis direction, and in which the pair of the first fulcrum portions 51 are disposed, and a pair of the second groove portions 37 extending from the middle concave portion 35 to both sides of the holder 3 in the second axis direction, and being opened to an outer circumferential surface of the holder 3 in the second axis direction. The pair of the second extension portions 57 extend to the outside of the holder 3 through the pair of the second groove portions 37. In this way, in the present embodiment, a shape associated with a part shape and a part layout of the gimbal mechanism 5 is secured in the holder 3. Therefore, assembling easiness of the gimbal mechanism 5 can be enhanced.

In the present embodiment, the first stopper portion 71 facing the frame middle portion 55 in a direction along the central axis line L is provided on an inner surface of the middle concave portion 35. The frame middle portion 55 is a portion in which a moving distance in the Z-axis direction when the holder 3 swings with respect to the gimbal frame 50 is small. Therefore, utilizing this portion as a stopper mechanism enables to reduce the gap S1 between the first stopper portion 71 and the frame middle portion 55. Accordingly, it is possible to enhance a function as a shock resistant stopper.

In the present embodiment, the support body 4 includes the bottom portion 42 being located on a side opposite to the mirror 2 with respect to the holder 3. The bottom portion 42 includes the circular convex portion 48 protruding toward the holder 3. The second stopper portion 72 facing the frame middle portion 55 is provided at a lead end of the circular convex portion 48. As described above, the frame middle portion 55 is a portion in which a moving distance in the Z-axis direction when the holder 3 swings with respect to the gimbal frame 50 is small. Therefore, utilizing this portion as a stopper mechanism enables to reduce the gap S2 between the second stopper portion 72 and the frame middle portion 55. Accordingly, it is possible to enhance a function as a shock resistant stopper.

In the present embodiment, the support body 4 includes the bottom portion 42 being located on a side opposite to the mirror 2 with respect to the holder 3. The bottom portion 42 includes the circular convex portion 48 protruding toward the holder 3 and being disposed inside of the holder concave portion 34. The third stopper portion 73 facing the outer circumference of the circular convex portion 48 is provided on an inner surface of the holder concave portion 34. In this way, in the present embodiment, since a stopper mechanism that restricts a swing range can be provided inside of the holder 3, it is not necessary to provide a stopper shape outside of the holder 3. Therefore, it is possible to make the device compact.

In the present embodiment, the third stopper portion 73 is an inclined surface being inclined in a direction toward an inner circumference of the third stopper portion 73, as being directed toward the swing center P. This enables to restrict a swing range in swinging about the swing center P.

In the present embodiment, in a case where an axis intersecting with the central axis line L, the first axis R1, and the second axis R2 at the swing center P, and intersecting with each other within a plane including the first axis R1 and the second axis R2 is referred to as the Y-axis and the X-axis, the holder 3 includes a pair of the first magnet fixing portions 33X facing both sides of the holder 3 in the Y-axis direction, and a pair of the second magnet fixing portions 33Y facing both sides of the holder 3 in the X-axis direction. The support body 4 includes a pair of the first coil fixing portions 45X facing each of the pair of the first magnet fixing portions 33X in the Y-axis direction, and a pair of the second coil fixing portions 45Y facing each of the pair of the second magnet fixing portions 33Y in the X-axis direction. The swing magnetic drive mechanism 6 includes the first magnetic drive mechanism 6X including the first magnet 61X to be fixed to the pair of the first magnet fixing portions 33X, and the first coil 62X to be fixed to the pair of the first coil fixing portions 45X, and the second magnetic drive mechanism 6Y including the second magnet 61Y to be fixed to the pair of the second magnet fixing portions 33Y, and the second coil 62Y to be fixed to the pair of the second coil fixing portions 45Y. This enables to utilize an angular position at which the first fulcrum portion 51 and the second fulcrum portion 52 of the gimbal mechanism 5 are not disposed as an installation space for a magnet and a coil. Therefore, it is possible to reduce the plane size of the device.

In the present embodiment, the first magnet 61X is disposed at a position shifted to a side of the first axis R1 with respect to a center of the holder 3 in the X-axis direction. Further, the second magnet 61Y is disposed at a position shifted to a side of the first axis R1 with respect to a center of the holder 3 in the Y-axis direction. This enables to increase the size of the first magnet 61X and the second magnet 61Y, while avoiding interference with the second extension portion 57 of the gimbal frame 50 extending to the outside of the holder 3.

In the present embodiment, the first fulcrum portion 51 is in point contact with a lead end of the first extension portion 56 on the first axis R1, and the second fulcrum portion 52 is in point contact with a lead end of the second extension portion 57 on the second axis R2. As described above, this allows for the gimbal frame 50 to swingably support the holder 3 about the first axis, and enables to form a state in which the gimbal frame 50 is swingably supported about the second axis with respect to the support body 4.

Note that, the first fulcrum portion 51 may have a structure in which a lead of the first extension portion 56 is rotatably supported about the first axis. At least an embodiment of the present invention is not limited to a configuration including the concave curved surface 502 in point contact with the spherical body 501, as described in the present embodiment. Likewise, the second fulcrum portion 52 may have a structure in which a lead end of the second extension portion 57 is rotatably supported about the second axis.

In the present embodiment, the first spring member 53 that is elastically deformable in the first axis direction is disposed on the first fulcrum portion 51, and the second spring member 54 that is elastically deformable in the second axis direction is disposed on the second fulcrum portion 52. This allows for the concave curved surface 502 provided in each spring member to be urged against the spherical body 501 provided on the gimbal frame 50 by an elastic force of each spring member, thereby maintaining a state in which a center of the concave curved surface 502 is in point contact with the spherical body 501. Further, since it is easy to mount the gimbal frame 50 by flexing each spring member, assembling easiness of the gimbal mechanism 5 can be enhanced.

Note that, in the present embodiment, the spherical body 501 is fixed to the gimbal frame 50, the first spring member 53 is disposed on the first fulcrum portion 51, and the second spring member 54 is disposed on the second fulcrum portion 52. However, the first spring member 53 and the second spring member 54 may be fixed to the gimbal frame 50, and the spherical body 501 may be disposed on the first fulcrum portion 51 and the second fulcrum portion 52. For example, a metal plate to which the spherical body 501 is fixed may be attached to each of the first spring attachment portion 38 and the second spring attachment portion 47.

### SUMMARY

At least an embodiment of the present invention can provide the following configurations.

### (1)

A tilt device includes: a holder including a swing target attachment portion that fixes a swing target to an outside; a support body that surrounds an outer circumference of the holder; a gimbal mechanism that connects the holder and the support body; and a swing magnetic drive mechanism including a magnet to be fixed to one of the support body and the holder, and a coil to be fixed to the other of the support body and the holder. In a case where an axis intersecting with a central axis line connecting between a swing center located inside of the holder, and a position of the swing target when being attached to the swing target attachment portion at the swing center is referred to as a first axis, and an axis intersecting with the central axis line and the first axis at the swing center is referred to as a second axis, the gimbal mechanism includes a gimbal frame that swingably supports the holder about the first axis as a center. The gimbal frame is swingably supported about the second axis as a center with respect to the support body. The gimbal frame includes a frame middle portion that is disposed inside of the holder, a pair of first extension portions extending from the frame middle portion to both sides of the gimbal frame in a first axis direction along the first axis within a plane including the first axis and the second axis, and a pair of second extension portions extending to both sides of the gimbal frame in a second axis direction along the second axis within a same plane as the plane of the first extension portion. The pair of the first extension portions are connected to the holder via a pair of first fulcrum portions provided inside of the holder. The pair of the second extension portions extend to an outside of the holder, and are connected to the support body via a pair of second fulcrum portions provided outside of the holder.

### (2)

The tilt device according to (1), wherein the gimbal frame is a plate-shaped rigid body in which a direction perpendicular to the plane is a plate thickness direction.

### (3)

The tilt device according to (2), wherein the gimbal frame includes a reinforcement portion that is recessed in the frame middle portion in the plate thickness direction.

### (4)

The tilt device according to any one of (1) to (3), wherein the holder includes a holder concave portion being opened in a direction along the central axis line. The holder concave portion includes a middle concave portion in which the frame middle portion is disposed, a pair of first groove portions extending from the middle concave portion to both sides of the holder in the first axis direction, and in which the pair of the first fulcrum portions are disposed, and a pair of second groove portions extending from the middle concave portion to both sides of the holder in the second axis direction, and being opened to an outer circumferential surface of the holder in the second axis direction. The pair of the second extension portions extend to an outside of the holder through the pair of the second groove portions.

### (5)

The tilt device according to (4), wherein a first stopper portion facing the frame middle portion in a direction along the central axis line is provided on an inner surface of the middle concave portion.

### (6)

The tilt device according to (4) or (5), wherein the support body includes a bottom portion being located on a side opposite to the swing target with respect to the holder. The bottom portion includes a convex portion protruding toward the holder. A second stopper portion facing the frame middle portion is provided at a lead end of the convex portion.

### (7)

The tilt device according to any one of (4) to (6), wherein the support body includes a bottom portion being located on a side opposite to the swing target with respect to the holder. The bottom portion includes a convex portion protruding toward the holder and being disposed inside of the holder concave portion. A third stopper portion facing the outer circumference of the convex portion is provided on an inner surface of the holder concave portion.

### (8)

The tilt device according to (7), wherein the third stopper portion is an inclined surface being inclined in a direction toward an inner circumference of the third stopper portion, as being directed toward the swing center.

### (9)

The tilt device according to any one of (1) to (8), wherein in a case where axes intersecting with the central axis line, the first axis, and the second axis at the swing center, and intersecting with each other within the plane are referred to as a third axis and a fourth axis, the holder includes a pair of first magnet fixing portions facing both sides of the holder in a fourth axis direction along the fourth axis, and a pair of second magnet fixing portions facing both sides of the holder in a third axis direction along the third axis. The support body includes a pair of first coil fixing portions facing each of the pair of the first magnet fixing portions in the fourth axis direction, and a pair of second coil fixing portions facing each of the pair of the second magnet fixing portions in the third axis direction. The swing magnetic drive mechanism includes a first magnetic drive mechanism including a first magnet to be fixed to the pair of the first magnet fixing portions, and the coil to be fixed to the pair of the first coil fixing portions, and a second magnetic drive mechanism including a second magnet to be fixed to the pair of the second magnet fixing portions, and the coil to be fixed to the pair of the second coil fixing portions.

### (10)

The tilt device according to (9), wherein the first magnet is disposed at a position shifted to a side of a diagonal position in the first axis direction with respect to a center of the holder in the third axis direction, and the second magnet is disposed at a position shifted to a side of a diagonal position in the first axis direction with respect to a center of the holder in the fourth axis direction.

### (11)

The tilt device according to any one of (1) to (10), wherein the first fulcrum portion is in point contact with a lead end of the first extension portion on the first axis, and the second fulcrum portion is in point contact with a lead end of the second extension portion on the second axis.

### (12)

The tilt device according to (11), wherein a first spring member that is elastically deformable in the first axis direction is disposed on one of the first fulcrum portion and a lead end of the first extension portion, and a second spring member that is elastically deformable in the second axis direction is disposed on one of the second fulcrum portion and a lead end of the second extension portion.

What is claimed is:

1. A tilt device comprising:
a holder comprising a swing target attachment portion that fixes a swing target to an outside;
a support body that surrounds an outer circumference of the holder;
a gimbal mechanism that connects the holder and the support body; and
a swing magnetic drive mechanism comprising a magnet to be fixed to one of the support body and the holder, and a coil to be fixed to the other of the support body and the holder, wherein
in a case where an axis intersecting with a central axis line connecting between a swing center located inside of the holder, and a position of the swing target when being attached to the swing target attachment portion at the swing center is referred to as a first axis, and an axis intersecting with the central axis line and the first axis at the swing center is referred to as a second axis,
the gimbal mechanism comprises a gimbal frame that swingably supports the holder about the first axis as a center, and the gimbal frame is swingably supported about the second axis as a center with respect to the support body,
the gimbal frame comprises a frame middle portion that is disposed inside of the holder, a pair of first extension portions extending from the frame middle portion to both sides of the gimbal frame in a first axis direction along the first axis within a plane comprising the first axis and the second axis, and a pair of second extension portions extending to both sides of the gimbal frame in a second axis direction along the second axis within a same plane as the plane of the first extension portion,
the pair of the first extension portions are connected to the holder via a pair of first fulcrum portions provided inside of the holder, and
the pair of the second extension portions extend to an outside of the holder, and are connected to the support body via a pair of second fulcrum portions provided outside of the holder.

2. The tilt device according to claim 1, wherein the gimbal frame is a plate-shaped rigid body in which a direction perpendicular to the plane is a plate thickness direction.

3. The tilt device according to claim 2, wherein the gimbal frame comprises a reinforcement portion that is recessed in the frame middle portion in the plate thickness direction.

4. The tilt device according to claim 1, wherein
the holder comprises a holder concave portion being opened in a direction along the central axis line,
the holder concave portion comprises a middle concave portion in which the frame middle portion is disposed, a pair of first groove portions extending from the middle concave portion to both sides of the holder in the first axis direction, and in which the pair of the first fulcrum portions are disposed, and a pair of second groove portions extending from the middle concave portion to both sides of the holder in the second axis direction, and being opened to an outer circumferential surface of the holder in the second axis direction, and
the pair of the second extension portions extend to an outside of the holder through the pair of the second groove portions.

5. The tilt device according to claim 4, wherein a first stopper portion facing the frame middle portion in a direction along the central axis line is provided on an inner surface of the middle concave portion.

6. The tilt device according to claim 4, wherein
the support body comprises a bottom portion being located on a side opposite to the swing target with respect to the holder, and
the bottom portion comprises a convex portion protruding toward the holder, and a second stopper portion facing the frame middle portion is provided at a lead end of the convex portion.

7. The tilt device according to claim 4, wherein
the support body comprises a bottom portion being located on a side opposite to the swing target with respect to the holder, and
the bottom portion comprises a convex portion protruding toward the holder and being disposed inside of the holder concave portion, and a third stopper portion facing the outer circumference of the convex portion is provided on an inner surface of the holder concave portion.

8. The tilt device according to claim 7, wherein the third stopper portion is an inclined surface being inclined in a direction toward an inner circumference of the third stopper portion, as being directed toward the swing center.

9. The tilt device according to claim 1, wherein
in a case where axes intersecting with the central axis line, the first axis, and the second axis at the swing center, and intersecting with each other within the plane are referred to as a third axis and a fourth axis,
the holder comprises a pair of first magnet fixing portions facing both sides of the holder in a fourth axis direction along the fourth axis, and a pair of second magnet fixing portions facing both sides of the holder in a third axis direction along the third axis,
the support body comprises a pair of first coil fixing portions facing each of the pair of the first magnet fixing portions in the fourth axis direction, and a pair of second coil fixing portions facing each of the pair of the second magnet fixing portions in the third axis direction,
the swing magnetic drive mechanism comprises
a first magnetic drive mechanism comprising a first magnet to be fixed to the pair of the first magnet fixing portions, and the coil to be fixed to the pair of the first coil fixing portions, and
a second magnetic drive mechanism comprising a second magnet to be fixed to the pair of the second magnet fixing portions, and the coil to be fixed to the pair of the second coil fixing portions.

10. The tilt device according to claim 9, wherein
the first magnet is disposed at a position shifted to a side of a diagonal position in the first axis direction with respect to a center of the holder in the third axis direction, and
the second magnet is disposed at a position shifted to a side of a diagonal position in the first axis direction with respect to a center of the holder in the fourth axis direction.

11. The tilt device according to claim 1, wherein
the first fulcrum portion is in point contact with a lead end of the first extension portion on the first axis, and
the second fulcrum portion is in point contact with a lead end of the second extension portion on the second axis.

12. The tilt device according to claim 11, wherein
a first spring member that is elastically deformable in the first axis direction is disposed on one of the first fulcrum portion and a lead end of the first extension portion, and
a second spring member that is elastically deformable in the second axis direction is disposed on one of the second fulcrum portion and a lead end of the second extension portion.
